(19) United States
(12) Patent Application Publication
(10) Pub. No.: US 2010/0291440 A1
(43) Pub. Date: Nov. 18, 2010

(54) Battery Electrode

(76) Inventors: Douglas J Miller, North Olmsted, OH (US); Gary Dale Shives, Brunswick, OH (US); Terence A. Pirro, Cleveland, OH (US)

Correspondence Address: GrafTech International Holdings, Inc., 12900 Snow Road, Parma, OH, 44130, US

(21) Appl. No.: 12/678,269

(22) PCT Filed: Sep. 12, 2008
(86) PCT No.: PCT/US08/76100

§ 371 Date: Jul. 10, 2010

Related U.S. Application Data
(60) Provisional application No. 60/980,433, filed on Oct. 16, 2007.

(51) Int. Cl. H01M 4/58; H01M 4/86; B05D 5/12

(52) U.S. Cl. 429/231.8; 252/182.1; 427/113

(57) ABSTRACT

A material suitable for use as an electrode for a battery, comprising an article which comprises carbonized fabric having an impregnant therein.

### BACKGROUND OF THE INVENTION TECHNICAL FIELD

Batteries, especially lead acid batteries, each include at least one electrode, and generally at least one positive electrode and one negative electrode, as well as an electrolyte solution. The reaction which permits the battery to store and release electrical energy occurs in a paste which is coated on and in the electrodes, with the role of the electrodes being to transfer current to and from the terminals of the battery. Thus, two characteristics of the material used for forming the electrodes of a lead acid battery is its ability to retain thereon or therein a sufficient amount of paste for the desired level of functioning, and the ability of the material to withstand the corrosive environment within the battery, due in large part to the sulfuric acid commonly used in the electrolyte.

In the past, there have been several proposed methods for inhibiting corrosion of battery electrodes, such as those formed of a lead grid. For instance, in G.Br. Patent No. 18,590, the electrodes are protected from corrosion by treating the electrode grids with a mixture of rubber, antimony, and graphite, by either dipping the grids into the mixture or by brushing the mixture onto the grids with a brush.

Contrariwise, in U.S. Pat. No. 7,105,252, a method of forming a coated electrode for a battery is proposed, where the electrode is exposed to an environment including vaporized carbon such that at least some carbon from the environment may be transferred to the electrode.

Unfortunately, prior attempts to provide an electrode material which is both capable of maintaining sufficient paste for proper functioning of the battery and which is sufficiently corrosion resistant have not been satisfactory. What is desired, then, is a material which is sufficiently dimensionally stable for functioning as an electrode material, has a high degree of porosity for maintaining a sufficient amount of paste on or in the electrode, and is sufficiently corrosion resistant. Moreover, a process for forming the desired material is also advantageous, especially when the process permits the formation of a wide variety of suitable materials, having differing porosities with highly controlled shape and size for different battery applications.

### BRIEF DESCRIPTION

Accordingly, it is an embodiment of the present invention to provide a material useful for forming, inter alia, an electrode in a battery which is sufficiently dimensionally stable for functioning as an electrode material, has high porosity for maintaining a sufficient amount of paste on or in the electrode.

It is another embodiment of the present invention to provide a material useful for forming, inter alia, an electrode in a battery having sufficient porosity for maintaining a sufficient amount of paste on or in the electrode, wherein the structure of the porosity is designed to provide efficient contacting of the paste with both the electrolyte and the electrode and the electrode material is sufficiently corrosion resistant and electrically conductive.

In another embodiment of the present invention, a material useful for forming, inter alia, an electrode in a lead acid battery which is not subject to extensive corrosion in an acidic environment over the expected lifetime of the lead acid battery is provided.

In is still another embodiment of the present invention a material useful for forming, inter alia, an electrode in a battery and which has sufficient rigidity to provide the structure needed is provided.

It is yet another embodiment of the present invention to provide a material useful for forming, inter alia, an electrode in a lead acid battery, which is sufficiently porous to permit paste to be incorporated thereinto.

Still another embodiment of the present invention provides a process for forming a material useful for forming an electrode in a battery which is sufficiently dimensionally stable for functioning as an electrode material, has large scale porosity for maintaining a sufficient amount of paste on or in the electrode, and is sufficiently corrosion resistant.

It is yet another embodiment of the present invention to provide a process for forming a material useful for forming an electrode in a lead acid battery, which can be used to produce materials having differing characteristics, as desired.

These embodiments and others which will be apparent to the skilled artisan upon reading the following description, can be achieved by providing a material suitable for use as an electrode for a battery, comprising an article which comprises carbonized cellulosic fabric, such as cotton (like cheesecloth), rayon or lyocell, having an impregnant therein, such as a resin or pitch; preferably, the article comprises a plurality (i.e., about 2 to about 10) of layers of carbonized fabric having an impregnant therein. For use as an electrode, the article should be porous, and at least some of the pores at least partially filled with paste.

The inventive article is produced by the process involving providing a starting article comprising at least one layer of a fabric; carbonizing the starting article to form a carbonized fabric; impregnating the carbonized fabric with a material selected from the group consisting of resin, pitch, or combinations thereof to form an impregnated article; curing the impregnated article in the case of impregnated articles to form a cured article; and carbonizing the cured article. Alternatively, the inventive process involves providing a starting article comprising at least one layer of a fabric; partially carbonizing the starting article to form a partially carbonized fabric; impregnating the partially carbonized fabric with a material selected from the group consisting of resin, pitch, or combinations thereof to form an impregnated article; curing the impregnated article in the case of impregnated articles to form a cured article; and completing carbonization of the cured article. Indeed, cure and completion of carbonization can be accomplished in one step. The fabric can be treated with a halide and/or a depolymerization inhibitor prior to carbonization. Moreover, the impregnation/cure steps can be repeated at least two times.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principles and operations of the invention.

### BRIEF DESCRIPTION OF THE DRAWINGS

FIG. 1 is a partially broken-away side perspective view of a lead acid battery containing an electrode in accordance with the present invention.

FIG. 2 is a plan view of an electrode in accordance with the present invention.

FIG. 3 is a cross-sectional view of the electrode of FIG. 2, taken along lines 3-3 of FIG. 2.

FIG. 4 is a partial plan view of the electrode of FIG. 2.

### DETAILED DESCRIPTION OF THE PREFERRED EMBODIMENT

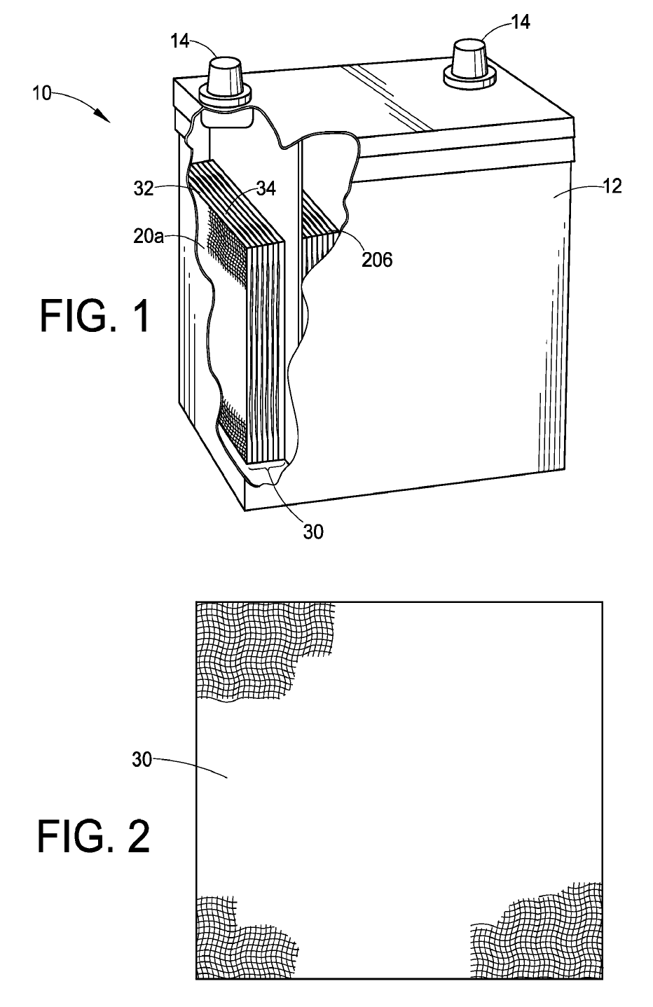

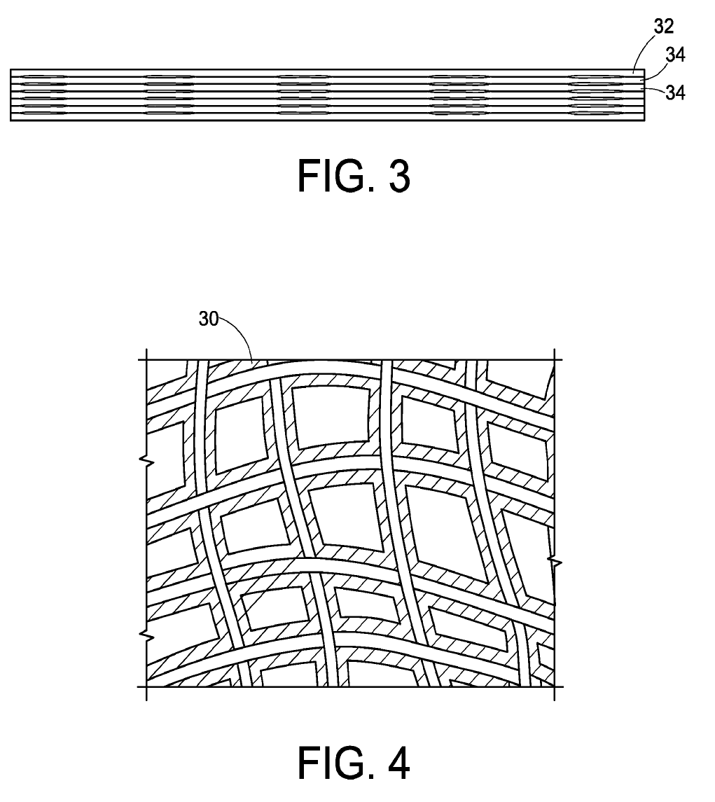

Referring now to the Figures, and especially to FIG. 1, an energy storage device such as a battery is denoted with the reference numeral 10. One embodiment of battery 10 may be a lead acid battery. Other examples of an energy storage device may include a capacitor or a super capacitor. Battery 10 generally comprises a case or housing 12 within which an electrolyte solution is maintained. Conventionally, the electrolyte solution consists of a mixture of sulfuric acid and water (especially distilled water), although other additives along with or in place of sulfuric acid and water can be employed. Also positioned within battery 10 is at least one cell 20, electrically connected with at least one battery terminal 14 positioned on an outer portion of case 12. Typically, battery 10 comprises a plurality of cells 20a, 20b, etc., connected in series or in parallel, depending on the desired capacity of battery 10.

Each cell 20a, 20b, etc. of battery 10 comprises a plurality of electrodes 30, alternating between positive electrodes 32 and negative electrodes 34, which are immersed in the electrolyte solution. Positive electrodes 32 are filled with a chemically active paste, such as lead dioxide (PbO₂) or other conventional materials, which serves as the active material of positive electrodes 32. Negative plates 34 may contain a lead dioxide paste as active material, or a different material such as a sponge lead material or other suitable material as the active material of negative plates 34. Sponge lead is a form of metallic lead brought to a spongy form by reduction of lead salts, or by compressing finely divided lead.

In operation, the potential difference that exists between the active material of positive electrode 32 and the active material of negative electrode 34 when immersed in the electrolytic solution causes electrons to flow from negative electrode 34 to positive electrode 32, and which reduces the lead dioxide at positive electrode 32 to form lead sulfate (PbSO₄); at negative electrode 34, sponge lead is oxidized to form lead sulfate. In a charging process, a counter-voltage may be applied to the battery terminals to force a current through the cells in a direction opposite to that in which the cell discharges. As a result, the cell reactions of the discharge process may be reversed. Specifically, the lead sulfate at positive electrode 32 is converted back to lead dioxide, and the lead sulfate at negative electrode 34 is converted back to sponge lead.

Accordingly, the material from which electrode 30 is formed must be capable of being filled with sufficient active material (i.e., lead dioxide paste or sponge lead) to provide battery 10 of which electrode 30 is an element with sufficient capacity. Accordingly, the material from which electrode 30 is formed may have large scale porosity, by which is meant sufficiently large pores to permit the pores of the material to be at least partially filled with a paste of the viscosity of lead dioxide or sponge lead pastes. It will be recognized by the skilled artisan that not all of the pores of an electrode 30 are filled with the active material paste, and that even those pores which have paste therein may not be 100% filled (volumetrically) with paste. Rather, when reference is made herein to filling the pores of a material with paste, what is being referred to is that a large enough fraction of the pores (typically at least about 30%, more typically at least about 40% and desirably between about 50% and about 100%) are sufficiently filled with paste (preferably at least about 25% on a volumetric basis, more preferably at least about 45% and most preferably between about 50% and about 100% on a volumetric basis) to permit effective use of the material as electrode 30 in battery 10. In one embodiment, the pore structure should retain a majority of the paste, preferably about all of the paste, more preferably all of the paste, and provide efficient contacting of the paste with both the electrolyte and the electrode.

In addition, the material from which electrodes 30 are formed should also be relatively resistant to corrosion, especially in the acidic environment of the electrolyte in a battery, especially a lead acid battery. More particularly, the material should be less corrosive (i.e., have a slower rate of corrosion) than conventional materials used to form battery electrodes, such as lead or alloys of lead with, for instance, antimony, cadmium, tin, or any other suitable elements. The corrosion rate can depend on, inter alia, ambient temperature, battery operating temperature, electrode potential, acid concentration in the electrolyte, etc., as well as the corrosion resistance offered by electrode 30. Corrosion may occur over a large area of each electrode 30, or it may occur at localized areas.

It will be recognized that the specific characteristics for the material used for the formation of electrodes 30 will vary with the particular battery application. In other words, for certain battery applications, greater porosity may be more beneficial than others; likewise, for certain battery applications, greater corrosion resistance will be more beneficial than others. Furthermore, the pore structure of the inventive material may be designed so as to provide an efficient use of paste, and the electrode material may be able to provide varying degrees of electrical and thermal conductivity for the particular requirements of particular embodiments of a battery. Accordingly, the process used to produce the inventive material should provide the flexibility to produce materials having differing characteristics depending on the particular battery or other application for which it is intended. In one particular embodiment, electrode 30 is employed as positive electrode 32. In addition to the above, in another particular embodiment, electrode 30 may be used as cathode of a super capacitor.

In accordance with the present invention, a material suitable for use as electrode 30 can be formed of a carbonized fabric, by which is meant a cloth made by weaving, knitting, stitching or felting fibers, and which is thereafter carbonized, especially by heat.

Suitable fabrics can include those which can be carbonized in high yield such as cellulose based textiles i.e. cotton, rayon, lyocell fabrics, or combinations thereof, and can be used singly or in layers. The design of the fabric as well as the scheme for layering contributes to the ultimate size and shape of the pores in the final electrode. In one embodiment, from 2 to about 19 layers of fabric have been found to be especially useful for the production of a material which can function as electrode 30 for battery 10. The choice of the fabric employed can be used to “engineer” the characteristics of the material used for electrode 30. In other words, the pore size and distribution of the starting fabric can determine the pore size and distribution of the finished material, and thus, the finished material can be tailored to the needs of the specific battery application for which it is intended. Indeed, a combination of fabrics having differing characteristics can be layered together to provide a unique carbonized material for use as electrode 30.

The first step in the process is to select or design and produce a fabric structure that has the desired thread diameter and size and shape of openings in the fabric to produce a material having the desired structure for electrode 30. One an embodiment of a preferred structure is a cotton cheesecloth of 10×25 threads per inch (“TPI”); a second embodiment is about a12×20 TPI cheesecloth; and a third embodiment is about 15×15 TPI cheesecloth. Preferred thread diameters range from about 150 to 400 microns, preferably at least 200 micron, more preferably about 250 microns.

The next step in the production of the material useful for electrode 30, at least one layer of a fabric is carbonized. When a plurality of layers are to be employed, the individual layers can be carbonized separately, before being laid up into the multi-layer material, or the fabric layers can be laid up prior to carbonization. In either case, carbonization of the fabric layer(s) occurs at a temperature between about 300° C. to about 1000° C., more preferably about 650° C. to about 800° C., in an inert or oxygen-free atmosphere, such as a nitrogen atmosphere. In one embodiment, carbonization temperatures are generally reached by raising the temperature in a slow and controlled manner, such as from about 5° C. to about 50° C. per hour, preferably up to 30° C. per hour, and the fabric is maintained at the carbonization temperature for a period of at least about several minutes to up to about 3 hours, preferably about 30 minutes up to about 2 hours, more preferably at least about 1 hour.

In one embodiment, the fabric is first impregnated with a halide to increase the carbon yield after carbonization, as discussed in U.S. Pat. No. 3,479,151, the disclosure of which is incorporated herein by reference. More specifically, carbonization occurs after impregnating the layers (either before or after being laid up) with a neutral or slightly acidic hygroscopic halide. In this case the carbonization process may be accelerated so that the total process time can be reduced to less than 1 hour. This makes practical a continuous carbonization furnace in which the fabric is fed from a roll at the inlet and the carbonized cloth is collected on a roll at the outlet.

The halide employed is preferably a neutral or slightly acidic salt, and may comprise, for example, calcium chloride, magnesium chloride, ammonium chloride, etc., or a halide of a metal such as aluminum or higher atomic weight metal such as titanium, manganese, zirconium, or thorium.

Advantageously, a depolymerization inhibitor may be employed during carbonization, together with the halide, to prevent loss of carbon from the structure, as by depolymerization and dissipation as carbon oxides, etc. The depolymerization inhibitor suitably comprises ammonia, an alkyl amine or an ammonium halide, or alkyl ammonium halide. It will be noted that the depolymerization inhibitor can also be the halide salt.

The neutral or slightly acidic halide salt (which optionally may incorporate the depolymerization inhibitor) may be impregnated into the fabric prior to carbonization. Impregnation is accomplished, for instance, by contacting the fabric in any suitable manner, as by spraying, etc., with the selected impregnant in a sufficient concentration. Usually, the selected halide salt is soluble or at least readily dispersible in water and, accordingly, is used in an aqueous solution or dispersion into which the fabric is immersed. Alternatively, alcohol or other suitable solvents or dispersants compatible with the fabric can also be used. A concentration of 0.1 mol or more of the halide salt is characteristically employed, usually about 0.5 mol or more. The impregnation of the fabric with the halide can be carried out for at least about 1 minute for sufficient effect, while times greater than about 5 minutes are generally not necessary.

If desired, drying of the impregnated fabric prior to carbonization can be carried out, for example by exposing the impregnated fabric to a temperature below carbonizing temperature. For example, impregnated cloth with calcium chloride in aqueous solution can be dried by heating the drained cloth in air to about 120° C. and holding it at that temperature for, for example, about 15 minutes. Carbonization of the impregnated fabric can then be initiated by increasing the temperature of the impregnated fabric, as described above.

After carbonization (or, as noted above, at least partial carbonization), the carbonized fabric is laid up into the desired number of layers in a support frame (if not laid up prior to carbonization) and impregnated with a resin or a pitch. The particular resin or pitch impregnant employed can vary depending on the particular characteristics desired for electrodes 30, as well as the operating environment of battery 10 (such as conditions like operating temperature, nature of the electrolyte, etc.). Resins found especially useful in the practice of the present invention include acrylic-, epoxy- and phenolic-based resin systems, fluoro-based polymers, or mixtures thereof. Some examples of suitable epoxy resin systems include those based on diglycidyl ether of bisphenol A (DGEBA) and other multifunctional resin systems; a non-limiting example of phenolic resins that can be employed include resole and novolac phenolics. Especially preferred is a furfuryl or polyfurfuryl resin system, employed with a catalyst such as maleic anhydride. Suitable resin or pitch content in the carbonized fabric is preferably enough to fill from about 50% to about 100% of available void space in the thread or yarn that makes up the fabric.

After impregnation, the impregnant is cured (although it will be recognized that the term cure is more applicable to resin impregnation, rather than pitch impregnation, the skilled artisan will understand what is meant by cure of a pitch impregnant; specifically, removal of the volatiles in the pitch), such as by bringing the impregnant to a temperature above the cure temperature of the particular impregnant system employed. For polyfurfuryl resin systems, curing at a temperature of at least about 130° C. should be sufficient, although the specific cure conditions would be within the skill of the artisan. While one application of impregnant is often sufficient, depending on the particular characteristics for electrode 30 that are desired, such as dimensional stability and rigidity, several cycles of resin impregnation/cure as described above may be effected. If the density of the material to make electrode 30 is a concern, the resin pickup may be tightly controlled. Such pickup may be controlled down to the level of individual layers. An air knife may be used to control the resin pick up by removing excess resin from the carbonized material. The number of passes under the air knife, the operation pressure of the knife, and the exposure time of the knife to the carbonized cloth may all be varied to control density. Another technique that may be used to control density is the use of a mask during the initial stages of the curing of the resin. This technique may be used to achieve a low density product. Lastly the spacing of the layers of the material apart and shrinkage of the material during curing and/or carbonization may be used to control density.

Once the threads are saturated with cured resin, additional treatments build on the surface of the threads that makeup the fabric. After each impregnation treatment the fabric is drained well or subjected to a flow of gas so as to keep impregnant from bridging the openings in the fabric that will ultimately become the pores of the carbon structure. For instance, at least 3 and up to 10 impregnation/cure cycles may be advantageously employed. In some instances more than 10 resin impregnation/cure cycles may be employed.

While impregnation with a resin is preferred, impregnation with a material other than a resin may be desirable, depending on the material characteristics desired. For instance, impregnation with a pitch may provide benefits, especially in terms of conductivity of the finished material.

After impregnation/cure, the resin impregnated fabric(s) is then subject to another carbonization step. As with the first, for this latter carbonization occurs at a temperature between about 300° C. to about 1000° C., more preferably about 650° C. to about 800° C., advantageously in an inert or oxygen-free atmosphere, such as a nitrogen atmosphere. Carbonization temperatures are generally reached by raising the temperature in a slow and controlled manner, such as from about 5° C. to about 50° C. per hour, and the material is maintained at the carbonization temperature for a period of at least about 30 minutes to about 2 hours, more preferably for about 1 hour. Further heat treatment to graphitizing temperatures of greater than about 2000° C., and generally in the range of about 2000° C. to about 3200° C. may also be undertaken to lower electrical resistance.

In another embodiment, during processing the fabric may be restrained, or otherwise held in position, in order to avoid warping and to ensure that the finished material has the proper shape, flatness or other special characteristics.

The resulting carbon or graphite article has the porous structure suitable for filling the pores with a paste, as is beneficial for use as electrodes 30 in battery 10. The presence of the paste within the porous structure permits the electrolyte to permeate through the body of electrode 30, and not just react at the face of the electrode; thus, the whole body of electrode 30 is a reaction site, not just the face. Moreover, the dimensional stability of the carbonized fabric and corrosion resistance makes it uniquely suitable for use as an electrode in a battery, especially a lead acid battery.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A material suitable for use as an electrode for an energy storage device, comprising an article which comprises carbonized fabric having an impregnant therein.

2. The material of claim 1, wherein the article comprises a plurality of layers of carbonized fabric having an impregnant therein.

3. The material of claim 2, wherein the article comprises from about 2 to about 10 layers of carbonized fabric having an impregnant therein.

4. The material of claim 1, wherein the fabric is comprised of cellulosic fibers such as cotton, rayon, lyocell or combinations thereof.

5. The material of claim 1, wherein the impregnant comprises a resin.

6. The material of claim 1, wherein the impregnant comprises pitch.

7. A lead acid battery, comprising an electrolyte and at least one electrode, wherein the electrode comprises a porous carbonized fabric, at least some of the pores of the carbonized fabric at least partially filled with a paste.

8. The battery of claim 7, wherein the electrode comprises a plurality of layers of carbonized fabric.

9. The battery of claim 7, wherein the fabric comprises cotton.

10. The battery of claim 7, wherein the fabric is graphitized.

11. A process for preparing a material suitable for use as an electrode for a lead acid battery, the process comprising:
(a) providing a starting article comprising at least one layer of a fabric;
(b) at least partially carbonizing the starting article to form a carbonized fabric;
(c) impregnating the carbonized fabric with a material selected form the group consisting of resin, pitch, or combinations thereof to form an impregnated article;
(d) curing the impregnated article to form a cured article; and
(e) carbonizing the cured article.

12. The process of claim 14, wherein the starting article comprises a plurality of layers of fabric.

13. The process of claim 14, wherein the starting article is treated with a halide prior to carbonization.

14. The process of claim 14, wherein the starting article is treated with a depolymerization inhibitor prior to carbonization.

15. The process of claim 14, wherein steps (c) and (d) are repeated at least two times.
